(19) United States
(12) Patent Application Publication
(10) Pub. No.: US 2008/0052249 A1
(43) Pub. Date: Feb. 28, 2008

(54) Investment allocation system, analysis module and method thereof

(76) Inventor: Jen-Her Jeng, LinNei Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,275

(22) Filed: May 31, 2007

(30) Foreign Application Priority Data
Aug. 24, 2006 (TW) 095131215

(51) Int. Cl. G06Q 40/00

(52) U.S. Cl. 705/36 R

(57) ABSTRACT

An investment allocation system, analysis module and method thereof for allocation of a total investment are disclosed. The investment allocation system comprises an input module, an analysis module and a allotment amount computation mode. The input module is used to input the historical data of a benchmark asset and multiple financial assets, and a threshold. The analysis module is used to calculate a robustness of each financial asset according to the threshold, and historical data of the benchmark asset and those financial assets. The allocation amount computation module is used to calculate an allocation ratio for each financial asset according to those robustnesses, related data, and a ratio computation procedure. and the allocation ratio each of those financial assets being multiplied by the total investment to produce the amount of allocation for each financial asset.

### BACKGROUND OF THE INVENTION

(a) Field of the Invention

The present invention is related to an investment allocation system, analysis module and method thereof, and more particularly, to analysis module and method thereof for calculating robustness of a financial asset and a system and its method to allocate investment pro rata according to robustness of the financial assets.

(b) Description of the Prior Art

As the living standard gets higher, investment and financing would receive more attention. Therefore, many securities agencies and bankers offer various types of portfolio of financial assets including funds, stocks and securities, the futures, foreign exchange, bonds, options, and subscription certificates for investors. However so far there is the absence of an effective analysis system to help investor analyze characteristics of a financial asset, e.g., level of consistent growth, consistent level of fluctuations, or adaptability level depending on the individual environment of economy. Investor only can rely upon the past performance of a financial asset in making subjective judgments about if the financial asset justifies investment. There is no resolution to objective and digital judgment of characteristics of the financial asset or making comparison between two assets for investment allocation.

Furthermore, the performance of the same financial asset varies depending on the economic conditions it faces at different times; that is, if the financial asset yields exact the same performance of return of investment (ROI) in a bull market and in a bear market, different assessments must be provided to achieve results of objective analysis. The shame is that up to now there is no such an analysis system to offer the function of providing objective analysis.

This inventor having been engaging in the research and development of financial investment and hands-on experience for years discloses an investment allocation system with its analysis module and method to bring a total solution for coping with those deficiencies as described above.

### SUMMARY OF THE INVENTION

The primary purpose of the present invention is to provide an investment allocation system with analysis module and method thereof for analyzing robustness of a financial asset that indicates the level of maintaining a consistent growth in the price of the financial asset for the investor to make the optimal allocation of investment amount.

To achieve the purpose, the present invention relates to an investment allocation system to make allocation from a total investment. The system includes an input module, an analysis module, and an allocation computation module. Wherein, a plurality of financial assets and data of their historical are input into the input module. The analysis module contains a threshold and historical data of a benchmark asset. Based on the threshold, the historical data of the benchmark asset, and the historical data of those financial assets, the analysis module calculates a robustness of each of those financial assets. Finally, the allocation computation module calculates an allocation ratio of each of financial assets according to those robustnesses and a ratio computation procedure. Each allocation ratio of financial assets is multiplied by the total investment respectively to produce an allocation of investment of each financial asset.

The present invention further provides an investment allocation method to allocate a total investment. The method is comprised of the following steps: firstly a plurality of financial assets and their historical data are input; a robustness of each financial asset is calculated according to a threshold, the historical data of a benchmark asset and those financial assets; an allocation ratio of each financial asset is then calculated based on at least the robustness and a ratio computation procedure; and finally the allocation ratio of each financial asset is multiplied by the total investment to produce the allocation of investment of each financial asset.

The present invention further produces an analysis module for calculating a robustness of a financial asset including a first numeric sequence comprised of multiple numbers. The analysis module includes a receiving unit, a storage unit, a return rate computation unit, a standard deviation computation unit, and a numeric value operation unit. The receiving unit is for receiving the first numeric sequence. The storage unit is for storing a benchmark asset and a threshold. The benchmark asset includes a second numeric sequence comprised of multiple numbers. The return rate computation unit calculates a first return rate sequence corresponding to a first numeric sequence and a second return rate sequence correspond to the second numeric sequence. The standard deviation computation unit calculates a first standard deviation sequence corresponding to a first return rate sequence and a second standard deviation sequence correspond to the second return rate sequence. The numeric operation unit performs operation on the first and the second standard deviation sequences based on a procedure of mathematical calculation procedure to produce a robustness of the financial asset.

The present invention also discloses an analysis method to calculate a robustness of a financial asset containing a first numeric sequence comprised of multiple numbers. The method includes the following steps: firstly a benchmark asset containing a second numeric sequence comprised of multiple numbers is provided; a first return rate sequence corresponding to the first numeric sequence and a second return rate sequence corresponding to the second numeric sequence are calculated; a first standard deviation sequence corresponding to the first return rate sequence and a second standard deviation sequence corresponding to the second return rate sequence are calculated; using an operation procedure and a threshold to operate the first and the second standard deviation sequences for generating a robustness.

The robustness indicates the consistent level of the price of the financial asset. The historical data of benchmark asset may be the weighted average of any group of global stock market index, world bonds index, world raw materials index, world real estate index, and world currencies.

An advantage of present invent is that the robustness of a financial asset is analyzed under different economic condition by referring to the benchmark asset.

Another advantage of present invent is that the investment allocation can be performed objectively and digitally by calculating the robustness of the financial asset.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block chart of an investment allocation system of the present invention;

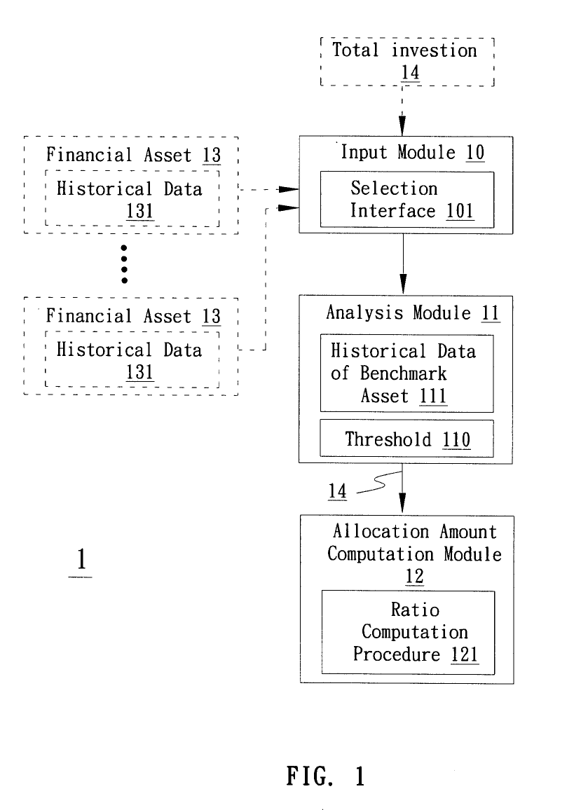

FIG. 2 is a schematic view showing an operation interface for the investment allocation system of the present invention;

FIG. 3 is a flow chart of an investment allocation method of the present invention;

FIG. 4 is a block chart of an analysis module of the present invention;

FIG. 5 is a flow chart of an analysis method of the present invention; and

FIG. 6 is a flow chart of a preferred embodiment of the analysis method of the present invention.

### DETAILED DESCRIPTION OF THE PREFERRED EMBODIMENTS

It is to be noted that to facilitate understanding, the same device whenever appears in any of the preferred embodiments of the present invention is marked with the same symbol.

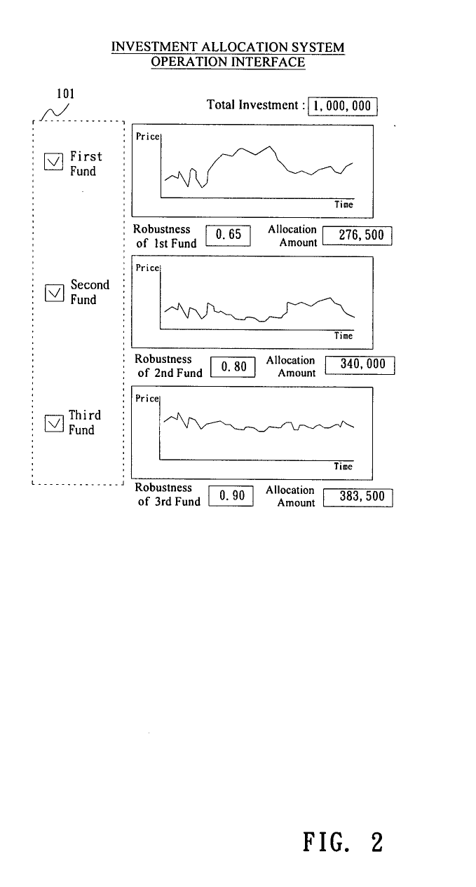

Referring to FIG. 2 for a block chart of an investment allocation system of the present invention, an investment allocation system 1 for performing allocation for a total investment 14 includes an input module 10, an analysis module 11, and a computation module 12. The total investment 14, a plurality of financial assets 13 and their historical data 131 are entered into the input module 10. The analysis module 11 containing a threshold 110 and a historical data 111 of a benchmark asset calculates a robustness 14 of each financial asset 13 based on the threshold 110, the historical data 111 of a benchmark asset, and the historical data 131 of those financial assets. The allocation amount computation module 12 calculates an allocation ratio of each financial asset 13 based on the robustness 14, a ratio computation procedure 121, and then the allocation ratio of each financial asset 13 is multiplied by the sum of investment 14 to produce the allocation amount for each financial asset 13. A selection interface 101 may be provided to the input module 10 as applicable for a user to select the desired benchmark asset from those financial assets 13 for investment.

The financial asset 13 may be one of funds, stocks and securities, futures, foreign exchange, bonds, options, and subscription certificates. The historical data are preferred to be that of traded prices at a plurality points of time of the financial asset 13, and The historical data of benchmark asset are preferred to be the weighted average of any group of global stock market index, world bonds index, world raw materials index, world real estate index, and world currencies. The ratio computation procedure involves normalization of the robustness of each financial asset to produce a normalized parameter, which becomes the allocation ratio of the financial asset.

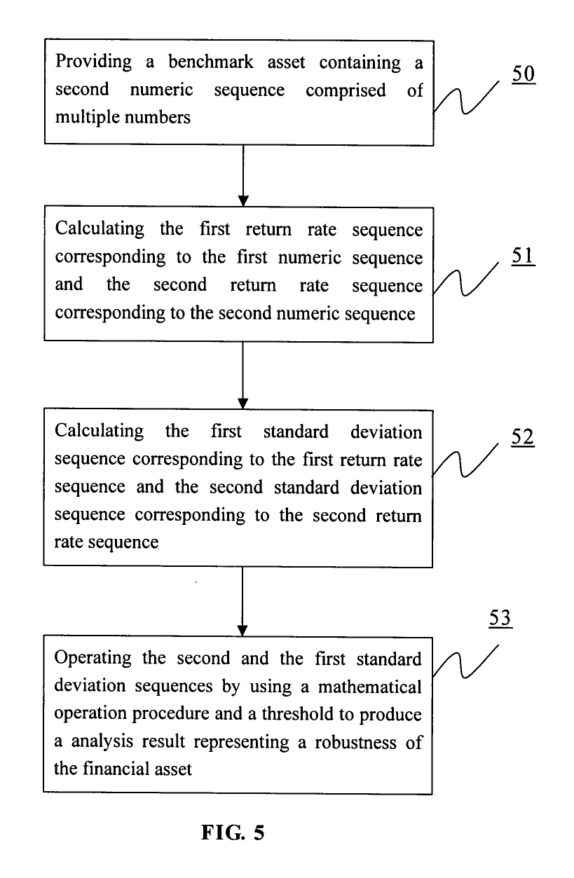

The robustness 14 represents the consistent level of the price of the financial asset 13. The robustness 14 also can represent the consistent level for the price of the financial asset 13 related to the benchmark asset. By reference of the benchmark asset, the investment allocation system 1 is capable of achieving objective analysis to reveal the robustness of the financial asset under different economic conditions. The computation process for the robustness 14 is as illustrated in FIG. 5 and will be discussed later.

The investment allocation system 1 may further contain an operation interface as applicable. As illustrated in FIG. 2, an operation interface 11 includes an selection interface 101 to provide more lots of funds, e.g., a first fund, a second fund, and a third fund as illustrated for investment selection. The operation interface 101 also displays a chart 20 of historical traded prices and the robustness of each fund. As illustrated, the robustness of the first fund is 0.65, the second fund, 0.80, and the third fund, 0.90. Therefore, a normalized robustness of each of these three funds is as follows:

0.2765=0.65/(0.65+0.80+0.9)

0.34=0.8/(0.65+0.80+0.9)

0.3835=0.9/(0.65+0.80+0.9)

### Given with a total investment at $1,000,000 and with these three normalized robustnesses as the allocation ratios, $276,500, $340,000 and $383,500 are allocated to the first fund, the second fund and, the third fund respectively.

The investment allocation system 1 may further include data regarding the level of risk exposure sustainable by an investor. According to depend on the data of the sustainable risks, the ratio computation procedure may perform a weighting operation for the robustness of each financial asset to produce a weighted robustness, and normalizes these weighted robustness to generate the normalized robustness serving as the allocation ratio for the financial asset. For example, if the risk exposure sustainable by the investor is low, a financial asset with a higher robustness may be adjusted up to a higher weighted ratio and another financial asset with a lower robustness may be adjusted to a lower weighted ratio.

Now referring to FIG. 2, because the first fund has the lowest robustness and the third fund has the highest robustness, a conservative investor who has lower level to sustain price drop may adjust the weighted ratios among these three funds to 1.1:1:0.9 with their corresponding weighted robustnesses respectively as follows:

0.585=0.65×0.9

0.8=0.8×1

0.99=0.9×1.1

Three normalized robustnesses respectively for three known weight robustnesses are then respectively calculated as follows:

0.2463=0.585/(0.585+0.80+0.99)

0.3368=0.8/(0.585+0.80+0.99)

0.4168=0.99/(0.585+0.80+0.99)

Again, given with the total investment at $1,000,000 and three normalized robustnesses as allocation ratios, the investment amount allocated to three funds are respectively, $246,300 for the first fund; $336,800, the second fund; and $416,800, the third fund. By changing the weighted ratio to respectively raise and reduce the investment amounts allotted to the third fund and the first fund. The investment allocation system of the present invention can provide the optimal investment allocation according to the characteristics of a certain financial asset and the risks the investor can take.

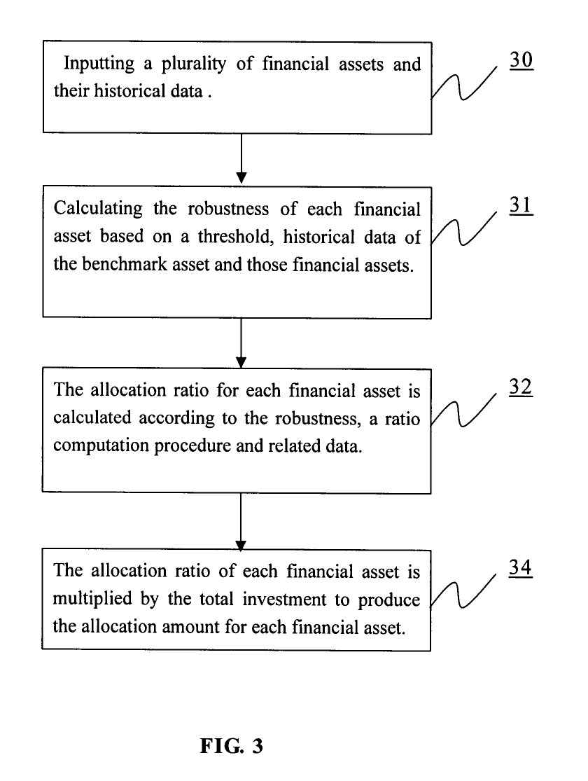

FIG. 3 shows a flow chart of steps of a method of the present invention for allocating a total investment. The investment allocation method includes the following steps:

Step 30: A plurality of financial assets and their historical data are input;

Step 31: a robustness of each financial asset is calculated based on a threshold, and historical data of a benchmark asset and those financial assets;

Step 32: an allocation ratio is calculated for each financial asset based on those robustnesses calculated in Step 31 and a ratio computation procedure;

Step 33: the allocation ratio for each financial asset is multiplied by the total investment to produce an investment amount allocated for each financial asset.

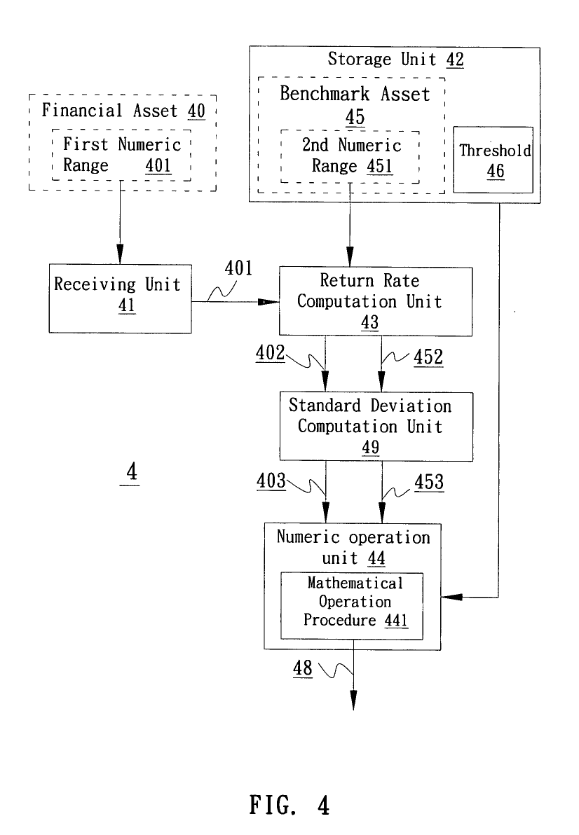

In a schematic view of an analysis module of the present invention as illustrated in FIG. 4, the analysis module 4 is operated to calculate a robustness of a financial asset 40. The financial asset 40 includes a first numeric sequence 401 comprised of multiple numbers. The analysis module 4 includes a receiving unit 41, a storage unit 42, a return rate computation unit 43, a standard deviation computation unit 49 and a numeric value operation unit 44. The receiving unit 41 receives the first numeric sequence 401. The storage unit 42 stores a benchmark asset 45 and a threshold 46, wherein the benchmark asset 45 includes a second numeric sequence comprised of multiple numbers. The return rate computation unit 43 calculates a first return rate sequence corresponding to the first numeric sequence 401 and a second return rate sequence corresponding to the second numeric sequence 451. The standard deviation computation unit 49 calculates a first standard deviation sequence corresponding to the first return rate sequence and a second standard deviation sequence corresponding to the second return rate sequence. The numeric value operation unit 44 operates the second standard deviation sequence 453 and the first standard deviation sequence 403 according to a mathematical operation procedure 441 and the threshold 46 for generating an analysis result 48 to represent the robustness of the financial asset 40.

An analysis method for calculating a robustness of a financial asset is comprised of those steps according to a flow chart as illustrated in FIG. 5. The financial asset contains a first numeric sequence comprised of multiple numbers. As illustrated, the analysis method of the present invention includes the following steps:

Step 50: a benchmark asset including a second numeric sequence comprised of multiple numbers is provided;

Step 51: a first return rate sequence corresponding to the first numeric sequence and a second return rate sequence corresponding to the second numeric sequence are calculated;

Step 52: a first standard deviation sequence corresponding to the first return rate sequence and a second standard deviation sequence corresponding to the second return rate sequence are calculated;

Step 53: A mathematical operation procedure and a threshold are used to operate the first and the second standard deviation sequences for generating a robustness.

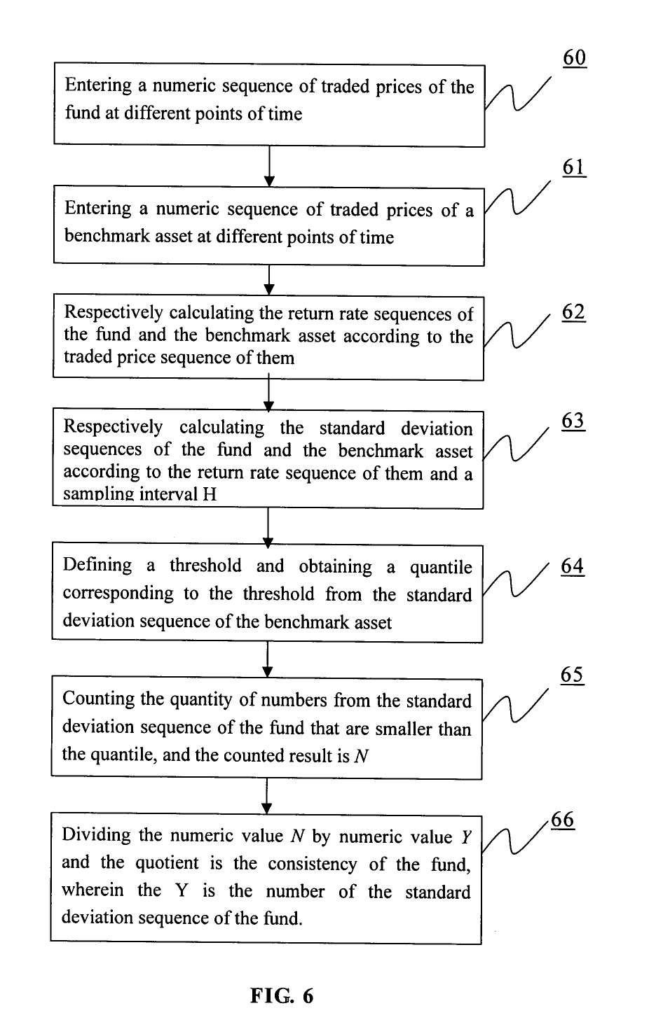

As illustrated in FIG. 6 for a flow chart showing a preferred embodiment of the analysis method of the present invention, the method for analyzing a robustness of a fund includes the following steps:

Step 60: A numeric sequence of prices of the fund at different points of time, V₁, V₂ . . . V_{H} . . . V_{Y+H+1} is input; wherein V₁ relates to a price of the fund at a point of time (1), V_{H} relates to a price of the fund at a point of time (H), and V_{Y+H+1} relates to a price of the fund at a point of time (Y+H+1);

Step 61: A numeric sequence of prices of a benchmark asset at different points of time, V′₁, V′₂ . . . V′_{H} . . . V′_{Y+H+1} is input; wherein V′₁ relates to a price of the benchmark asset at a point of time (1), V′_{H} relates to a price of the benchmark asset at a point of time (H), and V′_{Y+H+1} relates to a price of the benchmark asset at the point of time (Y+H+1);

Step 62: the return rate sequence, R₁, R₂, . . . , R_{H+1}, . . . , R_{Y+H+1} of the fund and the return rate sequence, R′₁, R′₂, . . . , R′_{H+1}, . . . , R′_{Y+H+1} of the benchmark asset within a time frame commencing from the point of time (H) until the point of time (Y+H+1) are calculated;

Step 62: the standard deviation computation interval is set as H, the standard deviation D_{H}, D_{H+1}, . . . , D_{Y+H+1} of the fund is obtained by calculating the standard deviation D of the H return rates before each time point, similarly, the standard deviation D′_{H}, D′_{H+1}, . . . , D′_{Y+H+1} of the benchmark asset is obtained by calculating the standard deviation D of the H return rates before each time point. D_{H} is the standard deviation of the H return rate between R₁ and R_{H}, D_{H+2} is the standard deviation of the H return rate between R₃ and R_{H+2}, and D′_{H} is the standard deviation of the H return rate between R′₁ and R′_{H}

Step 64: a threshold between 0˜1 is defined to obtain a quantile corresponding to the threshold from the standard deviation sequence D′_{H} . . . D′_{Y+H+1};

Step 65: a quantity of numbers with a value less than the quantile within the MDD numeric sequence D_{H}, D_{H+1} . . . D_{Y+H+1} is counted to obtain a numeric value N; and

Step 66: the numeric value N is divided by numeric value Y and the quotient resulted is the robustness of the fund.

A robustness indicates the consistent level of a financial asset price.

Accordingly, to judge which fund between the first fund and the second fund is likely to grow consistently in price, those steps disclosed above may be employed to respectively calculate the robustness of the first and the second funds. If the robustness of the first fund is greater than that of the second fund, the price of the first fund compared to the second fund could have better chance for consistent growth. Therefore, for a conservative investor who can take only lower risk may increase his investment in the first fund.

All those preferred embodiments given herein are only for examples without being restrictive; and any equivalent modification or alteration to those preferred embodiment within the spirits and scope of the present invention should be deemed as falling within the scope of claims to be claimed hereafter.

What is claimed is:

1. An investment allocation system for allocating a total investment, comprising:
an input module, for inputting a plurality of financial assets and their historical data;
an analysis module, containing a threshold and historical data of a benchmark asset, and for calculating a robustness of each of said financial assets according to said threshold, said historical data of the benchmark asset and said financial assets; and
an allocation amount computation module, for calculating an allocation ratio of each of said financial assets at least based on said robustnesses and a ratio computation procedure, and each allocation ratio of said financial assets being multiplied by said total investment to produce an allocation amount of investment for each of said financial assets.

2. An investment allocation system as claimed in claim 1, wherein said financial asset is one selected from funds, stocks and securities, futures, foreign exchanges, bonds, options, and subscription certificates.

3. An investment allocation system as claimed in claim 1, wherein said historical data include traded prices of the financial asset at multiple points of time.

4. An investment allocation system as claimed in claim 1, wherein said historical data of benchmark asset includes the weighted average of any group of global stock market index, world bonds index, world raw materials index, world real estate index, and world currencies.

5. An investment allocation system as claimed in claim 1, wherein said ratio computation procedure is for normalizing said robustness of each of said financial assets to produce a normalized robustness as said allocation ratio for said financial asset.

6. An investment allocation system as claimed in claim 1, further comprising a level of risk exposure sustainable by an investor.

7. An investment allocation system as claimed in claim 6, wherein said ratio computation procedure performs a weighting operation to said robustness of each of said financial assets based on said level of risk exposure sustainable by said investor, and said weighted robustness is normalized to be said allocation ratio for said financial asset.

8. An investment allocation system as claimed in claim 1, wherein said analysis module comprises a return rate computation unit, a standard deviation computation unit and a numeric value operation unit.

9. An investment allocation method to allocate a total investment, comprises:
inputting a plurality of financial assets and their historical data;
calculating a robustness of each of said financial assets based on a threshold, historical data of a benchmark asset and said financial assets;
calculating an allocation ratio of each of said financial assets based on said robustnesses and a ratio computation procedure, and said allocation ratio of each of said financial assets being multiplied by said total investment to produce the amount of allocation for each of said financial assets.

10. The investment allocation method as claimed in claim 9, wherein said financial asset is one selected from funds, stocks and securities, futures, foreign exchanges, bonds, options, and subscription certificates.

11. The investment allocation method as claimed in claim 9, wherein said historical data include traded prices of said financial asset at multiple points of time.

12. The investment allocation method as claimed in claim 9, wherein said historical data of benchmark asset includes the weighted average of any group of global stock market index, world bonds index, world raw materials index, world real estate index, and world currencies.

13. The investment allocation method as claimed in claim 9, wherein said ratio computation procedure performs a normalization operation for said robustness of each of said financial assets to produce a normalized robustness serving as said allocation ratio of said financial asset.

14. The investment allocation method as claimed in claim 13, wherein the ratio computation procedure further performs a weighting operation for said robustness of each of said financial assets according to a level of risk exposure sustainable by an investor, and said weighted robustness is then normalized to be said allocation ratio of said financial asset.

15. An analysis module for calculating a robustness of a financial asset containing a first numeric sequence comprised of multiple numbers, comprising:
a receiving unit, for receiving the first numeric sequence;
a storage unit, for storing a benchmark asset containing a second numeric sequence comprised of multiple numbers and a threshold;
a return rate computation unit, for calculating a first return rate sequence corresponding to said first numeric sequence and a second return rate sequence corresponding to said second numeric sequence;
a standard deviation computation unit, for calculating a first standard deviation sequence corresponding to said first return rate sequence and a second standard deviation sequence corresponding to said second return rate sequence;
a numeric value operation unit, for operating said second standard deviation sequence and said first standard deviation sequence based on a mathematical operation procedure and a threshold to produce said robustness.

16. The analysis module as claimed in claim 15, wherein said financial asset is one selected from funds, stocks and securities, futures, foreign exchanges, bonds, options, and subscription certificates.

17. The analysis module as claimed in claim 15, wherein those numbers included in said first numeric sequence are related to trade prices of said financial asset at multiple points of time.

18. The analysis module as claimed in claim 15, wherein said historical data of benchmark asset includes the weighted average of any group of global stock market index, world bonds index, world raw materials index, world real estate index, and world currencies.

19. An analysis method for calculating a robustness of a financial asset containing a first numeric sequence comprised of multiple number, comprising:
providing a benchmark asset containing a second numeric sequence comprised of multiple numbers;
calculating a first return rate sequence corresponding to the first numeric sequence and a second return rate sequence corresponding to the second numeric sequence;
calculating a first standard deviation sequence corresponding to said first return rate sequence and a second standard deviation sequence corresponding to said second return rate sequence;
using an operation procedure and a threshold to operate said second standard deviation sequence and said first standard deviation sequence to produce said robustness.

20. The analysis method as claimed in claim 19, wherein said financial asset is one selected from funds, stocks and securities, futures, foreign exchanges, bonds, options, and subscription certificates.

21. The analysis method as claimed in claim 19, wherein those numbers included in said first numeric sequence relate to traded prices of said financial asset at multiple points of time.

22. The analysis method as claimed in claim 19, wherein said historical data of benchmark asset includes the weighted average of any group of global stock market index, world bonds index, world raw materials index, world real estate index, and world currencies.
